(19) United States
(12) Patent Application Publication
(10) Pub. No.: US 2023/0017166 A1
(43) Pub. Date: Jan. 19, 2023

(54) MEASUREMENT DEVICE, MEASUREMENT METHOD, AND COMPUTER-READABLE MEDIUM

(71) Applicant: Panasonic Intellectual Property Management Co., Ltd., Osaka (JP)

(72) Inventor: Shigeaki SAKURAZAWA, Kanagawa Ken (JP)

(73) Assignee: Panasonic Intellectual Property Management Co., Ltd., Osaka (JP)

(21) Appl. No.: 17/864,020

(22) Filed: Jul. 13, 2022

(30) Foreign Application Priority Data
Jul. 13, 2021 (JP) 2021-115964

(51) Int. Cl. G01S 13/32; G01S 7/35

(52) U.S. Cl. CPC G01S 13/32; G01S 7/356

(57) ABSTRACT

A measurement device includes a memory; and a hardware processor coupled to the memory. The hardware processor is configured to: detect a vibration width of an antenna that receives a measurement target radio wave from a target on which a communication system that transmits the measurement target radio wave is mounted, based on a first reception radio wave received by the antenna; and derive communication performance of the communication system, based on a second reception radio wave that is the measurement target radio wave received by the antenna when the vibration width is greater than 0 and equal to or smaller than a set width greater than 0.

### CROSS-REFERENCE TO RELATED APPLICATIONS

This application is based upon and claims the benefit of priority from Japanese Patent Application No. 2021-115964, filed on Jul. 13, 2021, the entire contents of which are incorporated herein by reference.

### FIELD

The present disclosure relates to a measurement device, a measurement method, and a computer-readable medium.

### BACKGROUND

Conventionally, there are known systems that receive, by an antenna, a radio wave emitted from a communication system mounted on a target such as a mobile phone or a vehicle and derive communication performance of the communication system on the basis of the reception radio wave that has been received (see, for example, JP 2019-505768 A). Moreover, in a case of a large target, a large mechanism is prepared, and a radio wave is received while the mechanism is moved by a movable unit.

However, the antenna may shake due to an action by the movable unit or the like. In the related art, in order to suppress a decrease in measurement accuracy, measurement is performed after waiting until the shaking of an antenna completely stops by visual inspection. That is, in the related art, it is difficult to measure the communication performance of communication systems with high accuracy while an antenna is shaking.

An object to be solved by the present disclosure is to provide a measurement device, a measurement method, and a computer-readable medium capable of measuring communication performance of a communication system with high accuracy.

### SUMMARY

A measurement device according to the present disclosure includes a memory; and a hardware processor coupled to the memory. The hardware processor is configured to: detect a vibration width of an antenna that receives a measurement target radio wave from a target on which a communication system that transmits the measurement target radio wave is mounted, based on a first reception radio wave received by the antenna; and derive communication performance of the communication system, based on a second reception radio wave that is the measurement target radio wave received by the antenna when the vibration width is greater than 0 and equal to or smaller than a set width greater than 0.

### BRIEF DESCRIPTION OF THE DRAWINGS

FIG. 1 is a schematic diagram illustrating an example of a measurement system according to an embodiment;

FIG. 2 is a functional block diagram of an example of a measurement device;

FIG. 3 is a schematic graph of an example of a first reception radio wave;

FIG. 4 is a flowchart illustrating an example of a flow of information processing executed by the measurement device;

FIG. 5 is a schematic diagram illustrating an example of a measurement system according to an embodiment;

FIG. 6 is a functional block diagram of an example of a measurement device;

FIG. 7 is an explanatory diagram of an example of detection of a vibration width of an antenna by a detection unit;

FIG. 8 is a flowchart illustrating an example of a flow of information processing executed by the measurement device; and

FIG. 9 is a hardware configuration diagram of an example of the measurement device.

### DETAILED DESCRIPTION

Hereinafter, embodiments of a measurement device, a measurement method, and a computer-readable medium according to the present disclosure will be described with reference to the accompanying drawings.

### First Embodiment

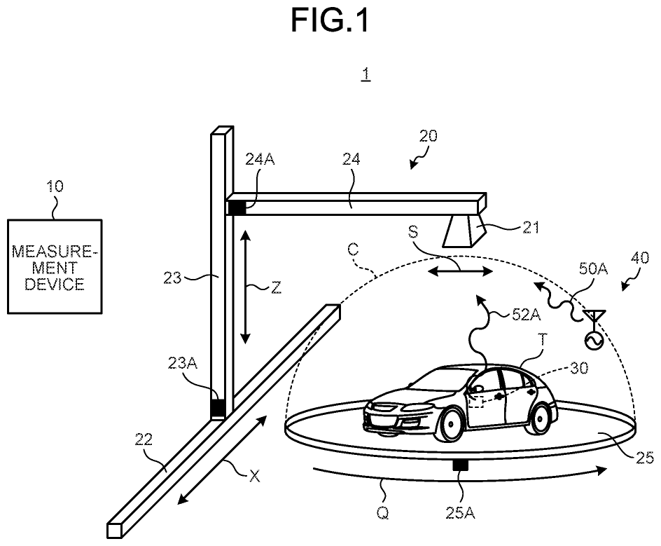

FIG. 1 is a schematic diagram illustrating an example of a measurement system 1 of the present embodiment. The measurement system 1 includes a measurement device 10, a measurement mechanism 20, and a fixed wave source 40.

The measurement system 1 is a system for measuring communication performance of a communication system 30 mounted on a target.

The target is an object on which the communication system 30 is mounted. The target may be any object as long as the communication system 30 can be mounted thereon.

Examples of the target include a vehicle T, a flying object such as an airplane, a ship, a structure such as a building, a mobile terminal, an electronic device such as a personal computer, or the like. In the present embodiment, a mode in which the target is a vehicle T will be described as an example.

The communication system 30 is a radio wave transmitter that wirelessly transmits a measurement target radio wave 52A. In other words, the communication system 30 is a radio wave transmitter that transmits the measurement target radio wave 52A into the air. Examples of the communication system 30 include a cordless telephone device, a wireless communication device such as a wireless fidelity (Wi-Fi) router, a radar transmitter, or the like. Examples of the communication system 30 also include various transmitters used for tracking, detection, communication, or the like. The measurement target radio wave 52A is a radio wave wirelessly transmitted from the communication system 30. The measurement target radio wave 52A is a radio wave to be measured in the measurement system 1 of the present embodiment. The measurement target radio wave 52A may be any of a millimeter wave, a microwave, a ultra short wave, a short wave, a medium wave, and a long wave. The millimeter wave is a radio wave in the millimeter wave frequency band of a frequency band greater than or equal to 26 GHz. The millimeter wave is used for a mobile communication system such as 5G (5th generation mobile communication system), autonomous driving technology of the vehicle T, advanced driver assistance system (ADAS) technology, and the like.

The radio waves used in the ADAS technology include, for example, radar.

In the present embodiment, the communication system 30 is mounted on the vehicle T which is an example of the target. In the present embodiment, a mode in which the communication system 30 is mounted in the vehicle T will be described as an example.

The measurement mechanism 20 is a mechanism for receiving the measurement target radio wave 52A transmitted from the communication system 30 mounted on the vehicle T.

The measurement mechanism 20 is capable of receiving the measurement target radio wave 52A at every position in all directions of the vehicle T with at least a part thereof being movable.

Specifically, the measurement mechanism 20 includes an antenna 21, a support 22, a support 23, and a support 24.

The antenna 21 is a device that wirelessly receives a radio wave and wirelessly transmits a radio wave. In other words, the antenna 21 emits a radio wave into the air and receives a radio wave propagated through the air.

The antenna 21 is supported by the support 24. The support 24 is a rod-shaped member. The support 24 supports the antenna 21 at one end in the longitudinal direction, and the other end thereof is supported by the support 23. In the present embodiment, a mode in which the support 24 is disposed so that the longitudinal direction of the support 24 substantially coincides with a direction intersecting the vertical direction will be described as an example.

The support 23 is a rod-shaped member. In the present embodiment, a mode in which the support 23 is disposed so that the longitudinal direction of the support 23 substantially coincides with the vertical direction will be described as an example. One end of the support 23 in the longitudinal direction is supported by the support 22. The support 22 is a rod-shaped member disposed on the ground or the like. In the present embodiment, a mode in which the longitudinal direction of the support 22 substantially coincides with the horizontal direction will be described as an example.

A support 25 is a member that supports the vehicle T. In the present embodiment, the support 25 is a disk-shaped member. In the present embodiment, the disk face of the support 25 is disposed in a direction along the horizontal direction. A drive unit 25A is provided at the center of the circle of the support 25. The drive unit 25A is driven under the control by the measurement device 10 described later. With the drive unit 25A driven, the support 25 rotates about the center of the circle by every predetermined angle (in the direction of arrow Q). As the support 25 rotates, the vehicle T placed on the support 25 rotates (in the direction of arrow Q).

The support 23 is provided with a drive unit 23A. The support 24 is provided with a drive unit 24A. The drive unit 23A and the drive unit 24A are driven under the control by the measurement device 10 described later. With the drive unit 23A driven, the support 23 moves along the longitudinal direction (direction of arrow X) of the support 22. With the drive unit 24A driven, the support 24 moves along the longitudinal direction (direction of arrow Z) of the support 23.

The antenna 21 supported by the support 24 is movably supported, with respect to the vehicle T, in a direction approaching or separating in the vertical direction and in a direction approaching or separating from a direction intersecting the vertical direction by driving of the drive unit 23A and the drive unit 24A. In other words, the antenna 21 is supported so as to be movable between the apex of a hemisphere C with the vehicle T as the center of the sphere and the peripheral edge of the hemisphere C by driving of the drive unit 23A and the drive unit 24A.

The fixed wave source 40 is a radio wave transmission source in a stationary state. In the present embodiment, the radio wave transmission source is a radio wave transmission device that wirelessly transmits a first transmission radio wave 50A. That is, the fixed wave source 40 is a radio wave transmission device that transmits the first transmission radio wave 50A into the air.

The first transmission radio wave 50A transmitted from the fixed wave source 40 is a constant radio wave whose wavelength, period, amplitude, and speed do not change with time. The period means the number of vibrations or a frequency. The speed is expressed by an absolute value of a speed. In the present embodiment, a mode in which the first transmission radio wave 50A is a sine wave will be described as an example.

The stationary state means that a non-vibrating state is maintained even in a case where at least one of the measurement device 10, the measurement mechanism 20, or the vehicle T vibrates. That is, the fixed wave source 40 is a radio wave transmission source that maintains a stationary state in which no vibration occurs even in a case where at least one of the measurement device 10, the measurement mechanism 20, or the vehicle T vibrates.

For example, the fixed wave source 40 is installed in a place that is not affected by the vibration of the measurement device 10, the measurement mechanism 20, or the vehicle T. Furthermore, for example, the fixed wave source 40 may be placed on a vibration-absorbing member that absorbs vibration.

The fixed wave source 40 may be any radio wave transmission source as long as the fixed wave source 40 transmits the first transmission radio wave 50A in the stationary state. As the fixed wave source 40, for example, the same radio wave transmission device as that of the communication system 30 may be used, or a different radio wave transmission device from that of the communication system 30 may be used. In a case where the same radio wave transmission device as that of the communication system 30 is used as the fixed wave source 40, the radio wave transmission device can be used as the fixed wave source 40 by installing the radio wave transmission device at a place where the stationary state is maintained.

Note that the fixed wave source 40 preferably maintains the stationary state and is disposed in an environment where no other member is interposed between the fixed wave source 40 and the antenna 21. Alternatively, the fixed wave source 40 preferably maintains the stationary state and is disposed in an environment where the state of other members interposed between the fixed wave source 40 and the antenna 21 does not change with time. The state of other members means factors that affect the radio wave received by the antenna 21 in the other members. The state of the other members refers to, for example, the type, the position, the shape, and the like of the other members.

Next, the measurement device 10 will be described. The measurement device 10 is a device that measures the communication performance of the communication system 30 on the basis of the measurement target radio wave 52A of the communication system 30 received by the antenna 21.

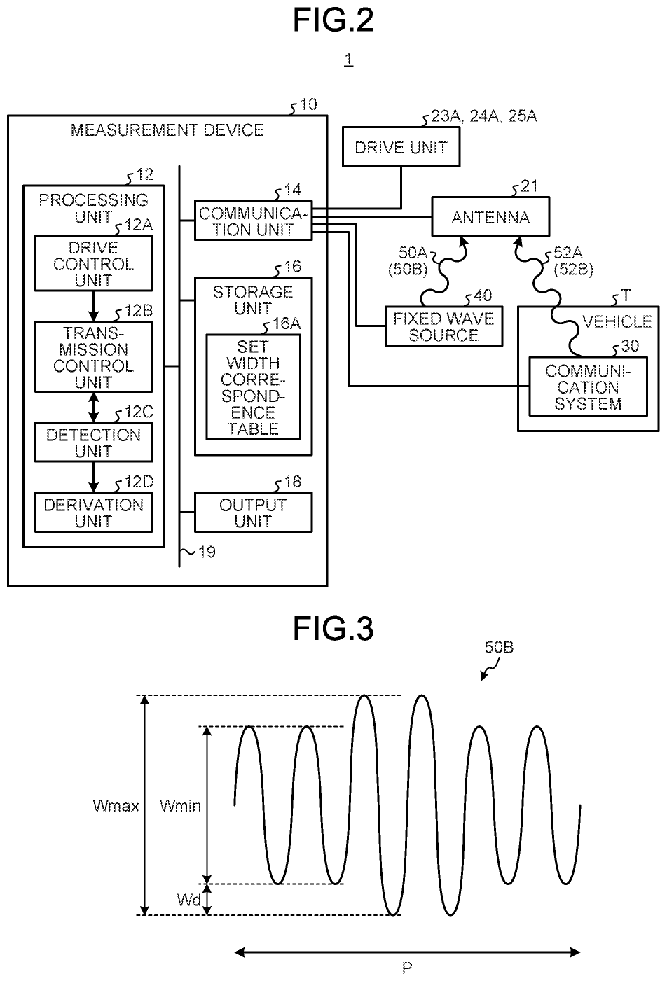

FIG. 2 is a functional block diagram of an example of the measurement device 10. In FIG. 2, electrical components included in the measurement system 1 other than the measurement device 10 are also illustrated.

The measurement device 10 includes a processing unit 12, a communication unit 14, a storage unit 16, and an output unit 18. The processing unit 12, the communication unit 14, the storage unit 16, and the output unit 18 are communicably connected via a bus 19, for example.

The communication unit 14 is communicably connected with the drive unit 23A, the drive unit 24A, the drive unit 25A, and the antenna 21. In the present embodiment, a mode in which the communication unit 14 is communicably connected with each of the drive unit 23A, the drive unit 24A, the drive unit 25A, and the antenna 21 by wire will be described as an example. Furthermore, in the present embodiment, a mode in which the communication unit 14 is communicably connected to each of the fixed wave source 40 and the communication system 30 by wire will be described as an example.

The storage unit 16 stores various types of information. The output unit 18 outputs various types of information. The output unit 18 is, for example, a display that displays an image, a speaker that outputs sound, or the like. Note that the output unit 18 may have a communication function of communicating with an external information processing device via a network or the like. With the communication function provided, the output unit 18 can transmit various types of information to an external information processing device.

The processing unit 12 executes various types of information processing. In the present embodiment, the processing unit 12 includes a drive control unit 12A, a transmission control unit 12B, a detection unit 12C, and a derivation unit 12D. Some or all of the drive control unit 12A, the transmission control unit 12B, the detection unit 12C, and the derivation unit 12D may be implemented by causing a processing device such as a central processing unit (CPU) to execute a program, that is, implementation by software, may be implemented by hardware such as an integrated circuit (IC), or may be implemented by using software and hardware in combination. Furthermore, at least one of the drive control unit 12A, the transmission control unit 12B, the detection unit 12C, and the derivation unit 12D may be mounted on an external information processing device communicably connected with the measurement device 10 via a network or the like.

The drive control unit 12A drives and controls the drive unit 23A, the drive unit 24A, and the drive unit 25A. For example, the drive control unit 12A drives the drive unit 23A, the drive unit 24A, and the drive unit 25A so that the antenna 21 is sequentially disposed in each of regions obtained by dividing the outer periphery of the hemisphere C (see FIG. 1) centered on the vehicle T into a plurality of regions. Specifically, the drive control unit 12A controls the drive unit 25A every time the position of the antenna 21 is controlled to move to a next measurement position between the apex of the hemisphere C and the peripheral edge of the hemisphere C by driving of the drive unit 23A and the drive unit 24A. Under the control by the drive unit 25A, the drive control unit 12A rotationally drives the vehicle T placed on the support 25 at every predetermined rotation angle.

In the measurement device 10, every time the antenna 21 is moved to a next measurement position by the drive control by the drive control unit 12A and the vehicle T placed on the support 25 is rotationally driven at a predetermined rotation angle, the communication performance of the communication system 30 is derived using a second reception radio wave 52B of the measurement target radio wave 52A received by the antenna 21. That is, the measurement device 10 is configured to be capable of acquiring the second reception radio wave 52B received in each of the regions obtained by dividing the outer periphery into a plurality of regions along the outer periphery of the hemisphere C centered on the vehicle T. In other words, the measurement device 10 is configured to be capable of acquiring the second reception radio wave 52B received at every position in all directions of the vehicle T.

The transmission control unit 12B controls the start and stop of transmission of radio waves in the fixed wave source 40 and the communication system 30.

Specifically, the transmission control unit 12B transmits a transmission start signal indicating the start of transmission of the first transmission radio wave 50A to the fixed wave source 40 via the communication unit 14. The fixed wave source 40 that has received the transmission start signal of the first transmission radio wave 50A starts to wirelessly transmit the first transmission radio wave 50A. In addition, the transmission control unit 12B transmits a transmission stop signal indicating stop of transmission of the first transmission radio wave 50A to the fixed wave source 40 via the communication unit 14. The fixed wave source 40 that has received the transmission stop signal of the first transmission radio wave 50A stops transmission of the first transmission radio wave 50A.

Furthermore, the transmission control unit 12B transmits a transmission start signal indicating the start of transmission of the measurement target radio wave 52A to the communication system 30 via the communication unit 14. The communication system 30 that has received the transmission start signal of the measurement target radio wave 52A starts to wirelessly transmit the measurement target radio wave 52A.

The transmission control unit 12B further transmits a transmission stop signal indicating stop of transmission of the measurement target radio wave 52A to the communication system 30 via the communication unit 14. The communication system 30 that has received the transmission stop signal of the measurement target radio wave 52A stops transmission of the measurement target radio wave 52A.

Note that the fixed wave source 40 and the communication system 30 may switch the start and stop of transmission of the first transmission radio wave 50A and the start and stop of transmission of the measurement target radio wave 52A by an operation instruction or the like by a user. Furthermore, the communication unit 14 may wirelessly transmit a transmission start signal and a transmission stop signal of the first transmission radio wave 50A to the fixed wave source 40. Similarly, the communication unit 14 may wirelessly transmit the transmission start signal and the transmission stop signal of the measurement target radio wave 52A to the communication system 30. In this case, the transmission control unit 12B is only required to transmit these transmission start signal and transmission stop signal via the antenna 21, for example.

The detection unit 12C detects the vibration width of the antenna 21. The detection unit 12C detects the vibration width of the antenna 21 on the basis of a reception radio wave received by the antenna 21.

The vibration width of the antenna 21 means a swing width of the antenna 21.

At least a part of the measurement mechanism 20 may vibrate. For example, as described above, in the measurement device 10, the antenna 21 is sequentially moved to a next measurement position by the drive control by the drive control unit 12A. Therefore, vibration is generated in the antenna 21 supported by the measurement mechanism 20 every time the antenna 21 is moved to a next measurement position. For example, vibration represented by a direction of an arrow S in FIG. 1 may be generated in the antenna 21. In addition, vibration may be generated in the antenna 21 due to factors other than the movement in the measurement mechanism 20.

In the present embodiment, the detection unit 12C detects the vibration width of the antenna 21 on the basis of a first reception radio wave 50B received by the antenna 21. The first reception radio wave 50B is the first transmission radio wave 50A, which has been transmitted from the fixed wave source 40, received by the antenna 21.

FIG. 3 is a schematic graph of an example of the first reception radio wave 50B. The detection unit 12C calculates a difference Wd between the maximum amplitude Wmax and the minimum amplitude Wmin of the first reception radio wave 50B in a predetermined period P as the vibration width of the antenna 21.

For the predetermined period P, a period from generation of vibration in the antenna 21 due to movement or the like to a stop of the vibration may be measured in advance a plurality of times, and the maximum value of the period may be used as the predetermined period P. The predetermined period P may be modifiable by an administrator or the like of the measurement mechanism 20.

As described above, the first transmission radio wave 50A transmitted from the fixed wave source 40 is a constant radio wave whose wavelength, period, amplitude, and speed do not change with time. Therefore, in a case where the first transmission radio wave 50A is received while the antenna 21 is not vibrating, the amplitude of the first reception radio wave 50B that is the reception radio wave of the first transmission radio wave 50A does not fluctuate. On the other hand, as the vibration of the antenna 21 increases, the difference Wd between the maximum amplitude Wmax and the minimum amplitude Wmin of the first reception radio wave 50B received by the antenna 21, which has been vibrating, increases.

Therefore, in the present embodiment, the detection unit 12C calculates the difference Wd between the maximum amplitude Wmax and the minimum amplitude Wmin of the first reception radio wave 50B in the predetermined period P as the vibration width of the antenna 21.

Returning to FIG. 2, the description will be continued.

The derivation unit 12D derives the communication performance of the communication system 30 on the basis of the second reception radio wave 52B that is the measurement target radio wave 52A received by the antenna 21 when the vibration width of the antenna 21 detected by the detection unit 12C is larger than 0 and equal to or smaller than a set width larger than 0.

Specifically, the derivation unit 12D derives the communication performance of the communication system 30 on the basis of the second reception radio wave 52B when the vibration width of the antenna 21 detected by the detection unit 12C is larger than 0 and equal to or smaller than a set width depending on the frequency of the measurement target radio wave 52A. More specifically, the derivation unit 12D derives the communication performance on the basis of the second reception radio wave 52B when the vibration width of the antenna 21 detected by the detection unit 12C is larger than 0 and equal to or smaller than a set width which becomes smaller as the frequency of the measurement target radio wave 52A is higher.

Specifically, as the set width, it is only required to set, in advance, the maximum value of the vibration width of the antenna 21 that does not affect the derivation of the communication performance of the communication system 30. In other words, as the set width, a value larger than 0 and less than the minimum value of the vibration width of the antenna 21 that affects the derivation of the communication performance of the communication system 30 may be set in advance. As described above, a value exceeding 0 is set in advance as the set width. That is, set in advance as the set width is not the state where the antenna 21 is not vibrating at all but a vibration width representing vibration of the antenna 21.

As the set width, a vibration width depending on the frequency of the measurement target radio wave 52A is set in advance. Specifically, it is only required to set in advance a smaller vibration width as the set width as the frequency of the measurement target radio wave 52A is higher. This is because, as the frequency of the measurement target radio wave 52A is higher, higher measurement accuracy, such as, in millimeters, is required to derive the communication performance of the communication system 30. On the other hand, it is only required to set in advance a larger vibration width as the set width as the frequency of the measurement target radio wave 52A is lower.

For example, the derivation unit 12D stores a set width correspondence table 16A in the storage unit 16 in advance.

The set width correspondence table 16A is a table in which the frequency of the measurement target radio wave 52A is associated with the set width. Note that the data format of the set width correspondence table 16A may be a database or the like and is not limited to tables.

The set width correspondence table 16A is a table in which a smaller set width is associated as the frequency of the measurement target radio wave 52A is higher. Moreover, the set width correspondence table 16A is a table in which a larger set width is associated as the frequency of the measurement target radio wave 52A is lower. Furthermore, in the set width correspondence table 16A, a set width representing a value exceeding 0 is registered in advance.

The derivation unit 12D acquires, from the communication system 30 via the communication unit 14, for example, the frequency of the measurement target radio wave 52A transmitted from the communication system 30. Note that the derivation unit 12D may acquire the frequency of the measurement target radio wave 52A input by an operation instruction by a user from an input unit such as a keyboard.

The derivation unit 12D reads, from the set width correspondence table 16A, the set width corresponding to the frequency of the measurement target radio wave 52A that has been acquired and thereby acquires the set width to be used for derivation.

The derivation unit 12D acquires the second reception radio wave 52B that is the measurement target radio wave 52A received by the antenna 21 when the vibration width of the antenna 21 detected by the detection unit 12C is larger than 0 and equal to or smaller than the set width that has been acquired. The derivation unit 12D derives communication performance of the communication system 30 by using the second reception radio wave 52B that has been acquired.

For example, the derivation unit 12D derives, as the communication performance, information in which information representing the second reception radio wave 52B that has been acquired is associated with position information of the antenna 21 in the real space at the time of acquisition of the second reception radio wave 52B. As the position of the antenna 21 in the real space, a position on the outer surface of the hemisphere C of the antenna 21 derived by the control of the drive unit 23A, the drive unit 24A, and the drive unit 25A by the drive control unit 12A may be used.

Note that the derivation unit 12D is only required to use at least one of the amplitude, the wavelength, the period, and the speed of the second reception radio wave 52B that have been acquired as the information representing the second reception radio wave 52B.

Next, an example of a flow of information processing executed by the measurement device 10 of the present embodiment will be described.

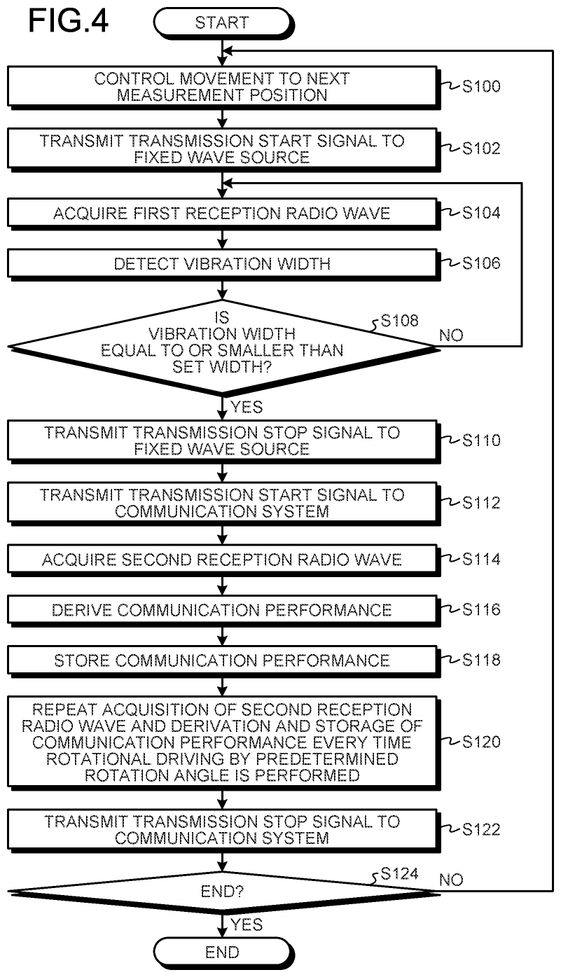

FIG. 4 is a flowchart illustrating an example of a flow of information processing executed by the measurement device 10. In a state immediately before the flowchart illustrated in FIG. 4 is executed, description will be given on the premise that the fixed wave source 40 and the communication system 30 are in a state of not transmitting radio waves. Furthermore, description will be given on the premise that the derivation unit 12D has acquired the frequency of the measurement target radio wave 52A transmitted from the communication system 30 before execution of the flowchart illustrated in FIG. 4.

The drive control unit 12A controls the movement of the antenna 21 to a next measurement position (step S100). The drive control unit 12A drives and controls the drive unit 23A and the drive unit 24A to move the position of the antenna 21 on the outer periphery of the hemisphere C (see FIG. 1) centered on the vehicle T to the next measurement position between the apex of the hemisphere C on the outer periphery and the peripheral edge of the hemisphere C.

The transmission control unit 12B transmits a transmission start signal indicating the start of transmission of the first transmission radio wave 50A to the fixed wave source 40 (step S102). The fixed wave source 40 that has received the transmission start signal starts transmission of the first transmission radio wave 50A.

The detection unit 12C acquires the first reception radio wave 50B that is the first transmission radio wave 50A received by the antenna 21 (step S104). The detection unit 12C acquires the first reception radio wave 50B from the antenna 21 via the communication unit 14.

The detection unit 12C detects the vibration width of the antenna 21 on the basis of the first reception radio wave 50B acquired in step S104 (step S106). The detection unit 12C calculates the difference Wd between the maximum amplitude Wmax and the minimum amplitude Wmin of the first reception radio wave 50B in the predetermined period P acquired in step S104 as the vibration width of the antenna 21.

The derivation unit 12D determines whether the vibration width of the antenna 21 detected in step S106 is larger than 0 and equal to or smaller than the set width (step S108). The derivation unit 12D reads the set width corresponding to the frequency of the measurement target radio wave 52A from the set width correspondence table 16A. Then, the derivation unit 12D determines whether or not the vibration width of the antenna 21 detected in step S106 is larger than 0 and equal to or smaller than the set width that has been read.

If it is determined that the vibration width exceeds the set width (step S108: No), the process returns to step S104 described above. On the other hand, if it is determined that the vibration width is larger than 0 and equal to or smaller than the set width (step S108: Yes), the process proceeds to step S110. Note that the derivation unit 12D may make an affirmative determination in step S108 also in a case where it is determined that the vibration width is 0.

In step S110, the transmission control unit 12B transmits the transmission stop signal indicating the stop of transmission of the first transmission radio wave 50A to the fixed wave source 40 (step S110). The fixed wave source 40 that has received the transmission stop signal stops transmission of the first transmission radio wave 50A.

Next, the transmission control unit 12B transmits the transmission start signal indicating the start of transmission of the measurement target radio wave 52A to the communication system 30 (step S112). The communication system 30 that has received the transmission start signal starts transmission of the measurement target radio wave 52A.

The derivation unit 12D acquires the second reception radio wave 52B that is the measurement target radio wave 52A received by the antenna 21 (step S114). The derivation unit 12D acquires the second reception radio wave 52B from the antenna 21 via the communication unit 14.

The derivation unit 12D derives the communication performance of the communication system 30 on the basis of the second reception radio wave 52B acquired in step S114 (step S116). The derivation unit 12D then stores the communication performance derived in step S116 in the storage unit 16 (step S118).

Then, the drive control unit 12A controls the drive unit 25A and thereby rotationally drives the vehicle T placed on the support 25 at every predetermined rotation angle. The derivation unit 12D repeats the acquisition of the second reception radio wave 52B in step S114, the derivation of the communication performance in step S116, and the storage of the communication performance in the storage unit 16 in step S118 every time the vehicle T is rotationally driven by the predetermined rotation angle (step S120). Then, when the rotation of the support 25 in the circumferential direction by 360° is completed by the rotation at every predetermined rotation angle, the process proceeds to step S122.

In step S122, the transmission control unit 12B transmits, to the communication system 30, the transmission stop signal indicating the stop of transmission of the measurement target radio wave 52A (step S122). The communication system 30 that has received the transmission stop signal stops transmission of the measurement target radio wave 52A.

Next, the processing unit 12 determines whether or not to end the measurement processing (step S124). For example, the processing unit 12 determines whether or not measurement of measurement positions in all directions along the outer periphery of the hemisphere C (see FIG. 1) centered on the vehicle T has been completed, thereby making the determination in step 3124. If a negative determination is made in step S124 (step S124: No), the process returns to step S100 described above. If an affirmative determination is made in step S124 (step S124: Yes), this routine is ended.

As described above, the measurement device 10 of the present embodiment includes the detection unit 12C and the derivation unit 12D. The detection unit 12C detects the vibration width of the antenna 21 that receives the measurement target radio wave 52A from the vehicle T, on which the communication system 30 that transmits the measurement target radio wave 52A is mounted, on the basis of the first transmission radio wave 50A received by the antenna 21. The derivation unit 12D derives the communication performance of the communication system 30 on the basis of the second reception radio wave 52B that is the measurement target radio wave 52A received by the antenna 21 when the vibration width is larger than 0 and equal to or smaller than a set width larger than 0.

As a target to be measured, such as the vehicle T, becomes larger, it is necessary to use a larger measurement mechanism 20 for derivation of the communication performance of the communication system 30 mounted on the target.

However, as the measurement mechanism 20 becomes larger, the influence of vibration propagated from each part of the measurement mechanism 20 to the antenna 21 becomes stronger. In addition, from the viewpoint of suppressing the influence of radio waves, there are cases where the measurement mechanism 20 is made of a nonmetallic material. In this case, the antenna 21 supported by the measurement mechanism 20 is more likely to vibrate.

Meanwhile, in the related art, measurement is performed after waiting until the shaking of the antenna 21 completely stops by visual inspection. That is, in the related art, it is difficult to perform highly accurate measurement while the antenna 21 is vibrating.

On the other hand, the detection unit 12C of the measurement device 10 of the embodiment detects the vibration width of the antenna 21 on the basis of the first transmission radio wave 50A received by the antenna 21. The derivation unit 12D derives the communication performance of the communication system 30 on the basis of the second reception radio wave 52B that is the measurement target radio wave 52A received by the antenna 21 when the vibration width is larger than 0 and equal to or smaller than a set width larger than 0.

Since the vibration width of the antenna 21 is detected on the basis of the first transmission radio wave 50A received by the antenna 21, the measurement device 10 of the present embodiment can detect the shaking of the antenna 21 with high accuracy. In addition, the measurement device 10 of the embodiment derives the communication performance of the communication system 30 on the basis of the second reception radio wave 52B that is the measurement target radio wave 52A received by the antenna 21 not when a detected vibration width is zero “0”, which indicates a state in which the shaking of the antenna 21 has completely stopped, but when the detected vibration width is greater than 0 and equal to or smaller than the set width larger than 0. Therefore, in the measurement device 10 of the embodiment, the communication performance of the communication system 30 can be derived, that is, measured with high accuracy even when the antenna 21 is vibrating.

Therefore, the measurement device 10 of the embodiment can measure the communication performance of the communication system 30 with high accuracy.

Moreover, the time it takes for the vibration of the antenna 21 to converge varies depending on the size of the measurement mechanism 20, the weight of the measurement mechanism 20, the size of the antenna 21, the weight of the antenna 21, or the like. In the related art, since the measurement is performed after waiting until the shaking of the antenna 21 completely stops by visual inspection, it takes time to perform the measurement.

On the other hand, the measurement device 10 of the embodiment derives the communication performance of the communication system 30 on the basis of the second reception radio wave 52B received by the antenna 21 when the vibration width that has been detected is larger than 0 and equal to or smaller than a set width larger than 0. Therefore, the measurement device 10 of the present embodiment can measure the communication performance of the communication system 30 with high accuracy without waiting until the shaking of the antenna 21 completely stops. Therefore, the measurement device 10 of the embodiment can shorten the measurement time in addition to the above effect.

### Second Embodiment

In the present embodiment, a mode will be described in which a reception radio wave of a reflected wave from a vehicle T is used as a first reception radio wave used for detection of the vibration width of an antenna 21 instead of the first transmission radio wave 50A received from the fixed wave source 40.

Note that in the present embodiment, the same symbols are given to parts indicating similar functions or configurations to those of the above embodiment, and detailed description thereof will be omitted.

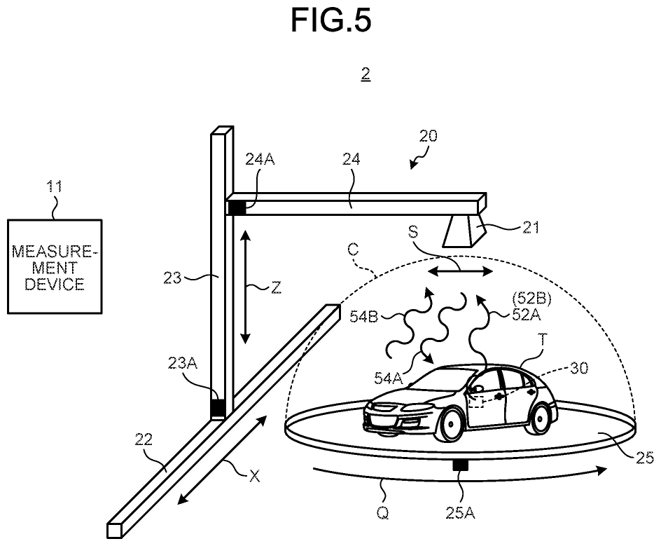

FIG. 5 is a schematic diagram illustrating an example of a measurement system 2 of the present embodiment. The measurement system 2 includes a measurement device 11 and a measurement mechanism 20. The measurement system 2 is similar to the measurement system 1 of the above embodiment except that the measurement system 2 includes the measurement device 11 instead of the measurement device 10 and does not include the fixed wave source 40.

The measurement device 11 is a device that measures the communication performance of a communication system 30 on the basis of a second reception radio wave 52B. The second reception radio wave 52B is a measurement target radio wave 52A of the communication system 30 received by the antenna 21. In the present embodiment, the measurement device 11 detects the vibration width of the antenna 21 using a first reception radio wave 54B that is a reflected wave, by the vehicle T, of a vibration-detecting radio wave 54A transmitted from the antenna 21 to the vehicle T.

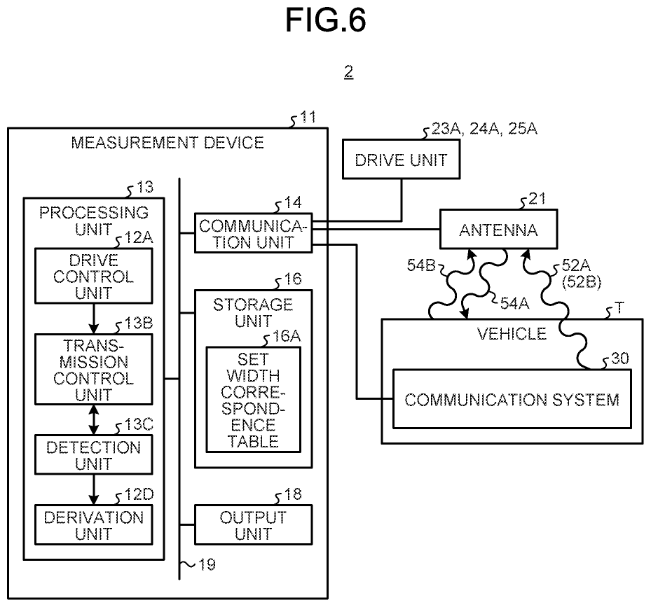

FIG. 6 is a functional block diagram of an example of the measurement device 11. In FIG. 6, electrical components included in the measurement system 2 other than the measurement device 11 are also illustrated.

The measurement device 11 includes a processing unit 13, a communication unit 14, a storage unit 16, and an output unit 18. The processing unit 13, the communication unit 14, the storage unit 16, and the output unit 18 are communicably connected via a bus 19, for example. The communication unit 14, the storage unit 16, and the output unit 18 are similar to those in the above embodiment.

The processing unit 13 executes various types of information processing. In the present embodiment, the processing unit 13 includes a drive control unit 12A, a transmission control unit 13B, a detection unit 13C, and a derivation unit 12D. Some or all of the drive control unit 12A, the transmission control unit 13B, the detection unit 13C, and the derivation unit 12D may be implemented by causing a processing device such as a CPU to execute a program, that is, by software, may be implemented by hardware such as an IC, or may be implemented software and hardware used in combination. Furthermore, at least one of the drive control unit 12A, the transmission control unit 13B, the detection unit 13C, and the derivation unit 12D may be mounted on an external information processing device communicably connected with the measurement device 11 via a network or the like.

The transmission control unit 13B controls the start and stop of transmission of radio waves in the communication system 30.

The transmission control unit 13B transmits a transmission start signal indicating the start of transmission of the measurement target radio wave 52A to the communication system 30 via the communication unit 14. The communication system 30 that has received the transmission start signal of the measurement target radio wave 52A starts to wirelessly transmit the measurement target radio wave 52A.

The transmission control unit 13B further transmits a transmission stop signal indicating the stop of transmission of the measurement target radio wave 52A to the communication system 30 via the communication unit 14. The communication system 30 that has received the transmission stop signal of the measurement target radio wave 52A stops transmission of the measurement target radio wave 52A.

Furthermore, the transmission control unit 13B causes the antenna 21 to transmit the vibration-detecting radio wave 54A.

The vibration-detecting radio wave 54A is a radio wave used for detection of vibration of the antenna 21. In the present embodiment, a mode in which the vibration-detecting radio wave 54A is a modulated wave will be described as an example. For example, the transmission control unit 13B outputs a transmission signal of the vibration-detecting radio wave 54A representing a pulse wave of a predetermined specific frequency to the antenna 21 via the communication unit 14. When receiving the transmission signal from the transmission control unit 13B via the communication unit 14, the antenna 21 starts transmitting the vibration-detecting radio wave 54A represented by the transmission signal.

The detection unit 13C detects the vibration width of the antenna 21. The detection unit 13C detects the vibration width of the antenna 21 on the basis of a reception radio wave received by the antenna 21.

In the present embodiment, the detection unit 12C detects the vibration width of the antenna 21 on the basis of the first reception radio wave 54B received by the antenna 21. The first reception radio wave 54B is a reception radio wave obtained by the antenna 21 receiving a reflected wave of the vibration-detecting radio wave 54A transmitted from the antenna 21 and reflected by the vehicle T. That is, the antenna 21 receives the first reception radio wave 54B that is a reflected wave of the first reception radio wave 54B reflected by the vehicle T. The detection unit 12C detects the vibration width of the antenna 21 on the basis of the first reception radio wave 54B.

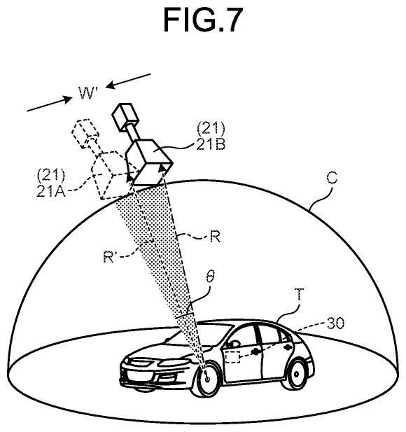

FIG. 7 is an explanatory diagram of an example of detection of a vibration width of the antenna 21 by the detection unit 12C.

The detection unit 12C calculates a distance R between the antenna 21 and the vehicle T on the basis of the vibration-detecting radio wave 54A and the first reception radio wave 54B.

For example, the detection unit 12C derives a time from transmission of the vibration-detecting radio wave 54A to reception of the first reception radio wave 54B that is a reflected wave of the vibration-detecting radio wave 54A by using a known time domain scheme or the like. Then the detection unit 12C calculates the distance R using the time from the transmission of the vibration-detecting radio wave 54A to the reception of the first reception radio wave 54B that is a reflected wave of the vibration-detecting radio wave 54A and the speed of the radio wave.

Note that the transmission control unit 13B may cause the antenna 21 to transmit a modulated wave by a frequency modulated continuous wave (FMCW) method as the vibration-detecting radio wave 54A. In this case, the detection unit 12C generates an intermediate frequency (IF) signal from the vibration-detecting radio wave 54A and the first reception radio wave 54B and performs known signal processing on the IF signal and thereby calculates the distance R. For example, the detection unit 12C derives a frequency spectrum by performing analog/digital (AD) conversion and further performing Fourier transform (FFT) on the IF signal. Then, the detection unit 12C calculates the distance R from the frequency spectrum that has been derived.

Alternatively, the detection unit 12C may calculate the distance R between the antenna 21 and the vehicle T on the basis of the difference between the intensity of the vibration-detecting radio wave 54A and the intensity of the first reception radio wave 54B. For example, the detection unit 12C stores the distance R corresponding to the difference between the amplitude intensity of the vibration-detecting radio wave 54A and the amplitude intensity of the first reception radio wave 54B in the storage unit 16 in advance in association with each other. Furthermore, the detection unit 12C may derive the distance R by reading, from the storage unit 16, a distance R corresponding to a difference between the amplitude intensity of the vibration-detecting radio wave 54A and the amplitude intensity of the first reception radio wave 54B.

Then the detection unit 12C calculates a difference between the calculated distance R between the antenna 21 and the vehicle T and a set distance R′. The set distance R′ is a distance between a presumed position of the antenna 21 in the real space and the vehicle T in the settings. As the presumed position of the antenna 21 in the real space, a position on the outer surface of the hemisphere C of the antenna 21 derived by the control of the drive unit 23A, the drive unit 24A, and the drive unit 25A by the drive control unit 12A may be used. In addition, as the position of the vehicle T, a position, which is obtained by adding the size of the vehicle T on the support 25 into consideration, may be calculated in advance and be used.

In a case where the antenna 21 does not vibrate, the distance R and the set distance R′ have the same value.

However, as illustrated in FIG. 7, for example, when the antenna 21 vibrates between the position of an antenna 21A and the position of an antenna 21B, the distance R and the set distance R′ have different values.

The detection unit 12C stores the difference between the distance R and the set distance R′ and the vibration width representing at least one of the shake angle θ and the shake amount W′ of the antenna 21 in the storage unit 16 in association with each other in advance. Then, the detection unit 12C reads the vibration width corresponding to the difference between the distance R and the set distance R′ from the storage unit 16, thereby detecting the vibration width representing at least one of the shake angle θ and the shake amount W′ of the antenna 21.

The detection unit 12C may calculate the vibration width by calculation from the difference between the distance R and the set distance R′. In this case, for example, the detection unit 12C is only required to calculate the vibration width representing at least one of the shake angle θ and the shake amount W′ of the antenna 21 by a trigonometric function using the distance R and the set distance R′.

Note that the detection unit 12C may calculate the vibration width of the antenna 21 from the transition of the distance R between the antenna 21 and the vehicle T in a set period, the transition calculated from the phase shift between the vibration-detecting radio wave 54A and the first reception radio wave 54B. For example, the detection unit 12C may calculate, as the vibration width of the antenna 21, a difference between the maximum distance R and the minimum distance R in the set period with respect to the distance R between the antenna 21 and the vehicle T.

Returning to FIG. 6, the description will be continued. The derivation unit 12D is similar to that of the above embodiment. In the present embodiment, the derivation unit 12D is only required to derive the communication performance of the communication system 30 on the basis of the second reception radio wave 52B received by the antenna 21 when the vibration width of the antenna 21 detected by the detection unit 13C instead of the detection unit 12C is larger than 0 and equal to or smaller than a set width larger than 0.

Next, an example of a flow of information processing executed by the measurement device 11 of the present embodiment will be described.

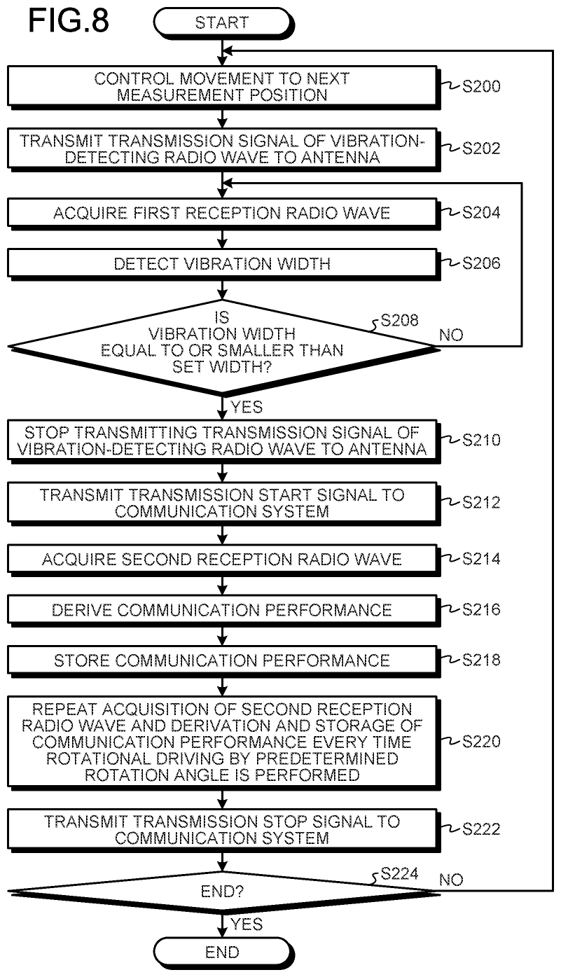

FIG. 8 is a flowchart illustrating an example of a flow of information processing executed by the measurement device 11. In a state immediately before the flowchart illustrated in FIG. 8 is executed, description will be given on the premise that the antenna 21 and the communication system 30 are in a state of not transmitting radio waves. Furthermore, description will be given on the premise that the derivation unit 12D has acquired the frequency of the measurement target radio wave 52A transmitted from the communication system 30 before execution of the flowchart illustrated in FIG. 8.

The drive control unit 12A controls the movement of the antenna 21 to a next measurement position (step S200). The drive control unit 12A drives and controls the drive unit 23A and the drive unit 24A to move the position of the antenna 21 on the outer periphery of the hemisphere C (see FIG. 5) centered on the vehicle T to the next measurement position between the apex of the hemisphere C on the outer periphery and the peripheral edge of the hemisphere C.

The transmission control unit 13B outputs the transmission signal of the vibration-detecting radio wave 54A to the antenna 21 via the communication unit 14 (step S202). The antenna 21 that has received the transmission signal of the vibration-detecting radio wave 54A starts transmitting the vibration-detecting radio wave 54A.

The detection unit 13C acquires the first reception radio wave 54B that is a reflected wave of the vibration-detecting radio wave 54A reflected by the vehicle T and received by the antenna 21 (step S204). The detection unit 13C acquires the first reception radio wave 54B from the antenna 21 via the communication unit 14.

The detection unit 13C detects the vibration width of the antenna 21 on the basis of the first reception radio wave 54B acquired in step S204 (step S206).

The derivation unit 12D determines whether the vibration width of the antenna 21 detected in step S206 is equal to or smaller than the set width (step S208). The derivation unit 12D reads the set width corresponding to the frequency of the measurement target radio wave 52A from the set width correspondence table 16A. Then, the derivation unit 12D determines whether or not the vibration width of the antenna 21 detected in step S206 is equal to or smaller than the set width that has been read.

If it is determined that the vibration width exceeds the set width (step S208: No), the process returns to step S204 described above. On the other hand, if it is determined that the vibration width is equal to or smaller than the set width (step S208: Yes), the process proceeds to step S210.

In step S210, the transmission control unit 13B stops transmitting the transmission signal of the vibration-detecting radio wave 54A to the antenna 21 (step S210). The antenna 21, to which the transmission of the transmission signal of the vibration-detecting radio wave 54A has been stopped, stops transmission of the vibration-detecting radio wave 54A.

Next, the transmission control unit 13B transmits the transmission start signal indicating the start of transmission of the measurement target radio wave 52A to the communication system 30 (step S212). The communication system 30 that has received the transmission start signal starts transmission of the measurement target radio wave 52A.

The derivation unit 12D acquires the second reception radio wave 52B that is the measurement target radio wave 52A received by the antenna 21 (step S214). The derivation unit 12D acquires the second reception radio wave 52B from the antenna 21 via the communication unit 14.

The derivation unit 12D derives the communication performance of the communication system 30 on the basis of the second reception radio wave 52B acquired in step S214 (step S216). The derivation unit 12D then stores the communication performance derived in step S216 in the storage unit 16 (step S218).

Then, the drive control unit 12A controls the drive unit 25A and thereby rotationally drives the vehicle T placed on the support 25 at every predetermined rotation angle. The derivation unit 12D repeats the acquisition of the second reception radio wave 52B in step S214, the derivation of the communication performance in step S216, and the storage of the communication performance in the storage unit 16 in step S218 every time the vehicle T is rotationally driven by the predetermined rotation angle (step S220). Then, when the rotation of the support 25 in the circumferential direction by 360° is completed by the rotation of the support 25 at every predetermined rotation angle, the process proceeds to step S222.

In step S222, the transmission control unit 13B transmits, to the communication system 30, the transmission stop signal indicating the stop of transmission of the measurement target radio wave 52A (step 3222). The communication system 30 that has received the transmission stop signal stops transmission of the measurement target radio wave 52A.

Next, the processing unit 13 determines whether or not to end the measurement processing (step S224). For example, the processing unit 13 determines whether or not measurement of measurement positions in all directions along the outer periphery of the hemisphere C (see FIG. 5) centered on the vehicle T has been completed, thereby making the determination in step S224. If a negative determination is made in step S224 (step S224: No), the process returns to step S200 described above. If an affirmative determination is made in step S224 (step S224: Yes), this routine is ended.

As described above, the detection unit 13C of the measurement device 11 of the present embodiment detects the vibration width of the antenna 21 on the basis of the first reception radio wave 54B that is a reflected wave, by the vehicle T, of the vibration-detecting radio wave 54A transmitted from the antenna 21 to the vehicle T. That is, the detection unit 13C of the present embodiment detects the vibration width of the antenna 21 on the basis of a phase shift between the vibration-detecting radio wave 54A and the first reception radio wave 54B. The derivation unit 12D derives the communication performance of the communication system 30 on the basis of the second reception radio wave 52B that is the measurement target radio wave 52A received by the antenna 21 when the vibration width is equal to or smaller than the set width larger than 0.

Therefore, as in the above embodiment, the measurement device 11 of the present embodiment can measure the communication performance of the communication system 30 with high accuracy even in a case where the antenna 21 is shaking.

Moreover, in the measurement device 11 of the present embodiment, the vibration width of the antenna 21 is detected on the basis of the first reception radio wave 54B that is a reflected wave, by the vehicle T, of the vibration-detecting radio wave 54A transmitted from the antenna 21 to the vehicle T. Therefore, the measurement device 11 of the present embodiment can detect the vibration width of the antenna 21 without separately providing a device for measuring the vibration of the antenna 21 such as an acceleration sensor.

Therefore, the measurement device 11 of the embodiment can suppress complication of the device in addition to the above effects.

Next, an example of a hardware configuration of the measurement device 10 and the measurement device 11 of the above embodiments will be described.

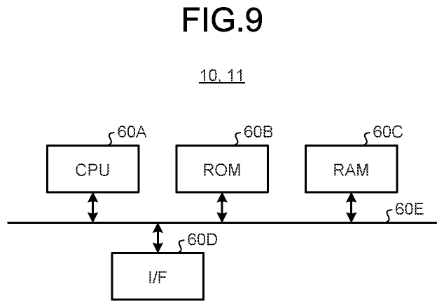

FIG. 9 is a hardware configuration diagram of an example of the measurement device 10 and the measurement device 11 of the above embodiments.

The measurement device 10 and the measurement device 11 of the above embodiments include a control device such as a CPU 60A, a storage device such as a read only memory (ROM) 60B, a random access memory (RAM) 60C, and a hard disk drive (HDD), an I/F unit 60D that is an interface with various devices, and a bus 60E that connects the units and have a hardware configuration using a normal computer.

In the measurement device 10 and the measurement device 11 of the above embodiments, the CPU 60A reads a program from the ROM 60B onto the RAM 60C and executes the program, whereby the above units are implemented on the computer.

Note that the program for executing each piece of the above processing executed in the measurement device 10 and the measurement device 11 of the above embodiments may be stored in the HDD. Alternatively, the program for executing each piece of the above processing executed in the measurement device 10 and the measurement device 11 of the above embodiments may be provided by being incorporated in the ROM 60B in advance.

Further alternatively, the program for executing each piece of the above processing executed in the measurement device 10 and the measurement device 11 of the above embodiments may be stored as a file in an installable format or an executable format in a computer-readable storage medium such as a CD-ROM, a CD-R, a memory card, a digital versatile disk (DVD), or a flexible disk (FD) and provided as a computer program product. Moreover, the program for executing each piece of the above processing executed in the measurement device 10 and the measurement device 11 of the above embodiments may be stored in a computer connected to a network such as the Internet and provided by being downloaded via the network. Furthermore, the program for executing each piece of the above processing executed in the measurement device 10 and the measurement device 11 of the above embodiments may be provided or distributed via a network such as the Internet.

According to a measurement device, a measurement method, and a computer-readable medium according to the present disclosure, communication performance of a communication system can be measured with high accuracy.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A measurement device comprising:
a memory; and
a hardware processor coupled to the memory,
the hardware processor being configured to:
detect a vibration width of an antenna that receives a measurement target radio wave from a target on which a communication system that transmits the measurement target radio wave is mounted, based on a first reception radio wave received by the antenna; and
derive communication performance of the communication system, based on a second reception radio wave that is the measurement target radio wave received by the antenna when the vibration width is greater than 0 and equal to or smaller than a set width greater than 0.

2. The measurement device according to claim 1, wherein the hardware processor is configured to derive the communication performance based on the second reception radio wave when the vibration width is larger than 0 and equal to or smaller than the set width depending on a frequency of the measurement target radio wave.

3. The measurement device according to claim 1, wherein the hardware processor is configured to derive the communication performance based on the second reception radio wave when the vibration width is larger than 0 and equal to or smaller than the set width which is smaller as a frequency of the measurement target radio wave is higher.

4. The measurement device according to claim 1, wherein
the antenna receives a first transmission radio wave transmitted from a fixed wave source that is a radio wave transmission source in a stationary state, and
the hardware processor is configured to detect, as the vibration width of the antenna, a difference between a maximum amplitude and a minimum amplitude in a predetermined period of the first reception radio wave that is the first transmission radio wave received by the antenna.

5. The measurement device according to claim 1, the hardware processor is further configured to transmit a vibration-detecting radio wave from the antenna, wherein
the antenna receives a reflected wave of the vibration-detecting radio wave reflected by the target, and
the hardware processor is configured to detect the vibration width based on the first reception radio wave that is the reflected wave received by the antenna.

6. The measurement device according to claim 5, wherein the hardware processor is configured to detect, as the vibration width, at least one of a shake angle or a shake amount of the antenna corresponding to a difference between a distance between the antenna and the target derived based on the vibration-detecting radio wave and the first reception radio wave, and a set distance between the antenna and the target.

7. A measurement method comprising:
detecting a vibration width of an antenna that receives a measurement target radio wave from a target on which a communication system that transmits the measurement target radio wave is mounted, based on a first reception radio wave received by the antenna; and
deriving communication performance of the communication system, based on a second reception radio wave that is the measurement target radio wave received by the antenna when the vibration width is greater than 0 and equal to or smaller than a set width greater than 0.

8. A non-transitory computer-readable medium on which an executable program is recorded, the program instructing a computer to carry out:
detecting a vibration width of an antenna that receives a measurement target radio wave from a target on which a communication system that transmits the measurement target radio wave is mounted, based on a first reception radio wave received by the antenna; and
deriving communication performance of the communication system, based on a second reception radio wave that is the measurement target radio wave received by the antenna when the vibration width is greater than 0 and equal to or smaller than a set width greater than 0.
